(19) United States
(12) Patent Application Publication
(10) Pub. No.: US 2013/0151071 A1
(43) Pub. Date: Jun. 13, 2013

(54) APPARATUS AND METHOD OF SETTING MAXIMUM OPENING ANGLE OF POWER TAIL GATE

(71) Applicant: Dae Hee Lee, Incheon (KR)

(72) Inventor: Dae Hee Lee, Incheon (KR)

(73) Assignees: Kia Motors Corp., Seoul (KR); Hyundai Motor Company, Seoul (KR)

(21) Appl. No.: 13/527,084

(22) Filed: Jun. 19, 2012

(30) Foreign Application Priority Data
Dec. 12, 2011 (KR) 10-2011-0133134

(51) Int. Cl. G06F 7/00

(52) U.S. Cl. 701/36

(57) ABSTRACT

Provided is an apparatus and method of setting the maximum opening angle of a powered tail gate for a vehicle. The maximum opening angle of the tail gate can be adjusted to an angle desired by a user, so that the ease of use by the user can be improved, and furthermore prevent the tail gate from being damaged.

### CROSS-REFERENCE TO RELATED APPLICATIONS

The present application claims priority of Korean Patent Application Number 10-2011-0133134 filed Dec. 12, 2011, the entire contents of which application is incorporated herein for all purposes by this reference.

### BACKGROUND OF INVENTION

1. Field of Invention

The present invention relates, in general, to an apparatus and method of setting a maximum opening angle of a power tail gate for a vehicle, and more particularly to an apparatus and method of setting a maximum opening angle of a power tail gate for a vehicle, capable of setting the tail gate to the maximum opening angle at the discretion of a user.

2. Description of Related Art

To suit the needs of users of vehicles, power tail gates have been developed so as to automatically open at a constant speed.

As shown in FIG. 1, a conventional power tail gate device is designed so that, when a dial switch 1 mounted in the interior of a vehicle is operated, a power supply 3 is operated by a control signal of a controller 2, and an actuator 6 made up of a linear electric motor 4 and a gas spring 5 is driven by the operation of the power supply 3. Thereby, the tail gate 7 automatically opens.

Here, the dial switch 1 is configured to be able to adjust a maximum opening angle of the tail gate 7 to a plurality of angles. For example, the configuration of the dial switch 1 be a quarter stage capable of maintaining the opening angle at 25%, a half stage capable of maintaining the opening angle at 50%, a three-quarter stage capable of maintaining the opening angle at 75%, and a full stage capable of maintaining the opening angle at 100%.

However, the conventional power tail gate device is designed so that the maximum opening angle of the tail gate 7 is uniformly set to the plurality of stages according to the operation of the dial switch 1. As such, the maximum opening angle of the tail gate 7 cannot be set at the discretion of the user, and thus the tail gate does not meet expectations.

For example, the maximum opening angle of the tail gate 7 needs to be between the three-quarter stage and the full stage due to physical conditions of the user or ambient circumstances such as a parking space. Since the conventional power tail gate device is designed so that the maximum opening angle of the tail gate 7 is previously set to the three-quarter stage or the full stage, the user cannot set the maximum opening angle of the tail gate 7 to a desired angle between the three-quarter stage and the full stage.

An exemplar of the prior art is U.S. Pat. No. 7,034,485 B2.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an apparatus and method of setting a maximum opening angle of a power tail gate for a vehicle, capable of setting a current opening angle of the tail gate which is opened by an angle which a user wants to be the maximum opening angle, and causing the tail gate to automatically open to the set maximum opening angle when the tail gate is opened the next time, so that the user can easily adjust the maximum opening angle of the tail gate.

Various aspects of the present invention provide for an apparatus for setting a maximum opening angle of a power tail gate for a vehicle, which includes: an actuator that is installed to connect a vehicle body and the tail gate, the actuator having a motor providing power to open and close the tail gate; a hall sensor that is installed on the actuator so as to be able to detect rotating direction and speed (rpm) of the motor; a memory switch that is operated by a user so as to be able to store information detected by the hall sensor in the state of an open tail gate.

The apparatus may include a controller that receives and stores the information from the hall sensor when the memory switch is operated, and controls operation of a power supply supplying power to the motor on the basis of the stored information from the hall sensor when a main switch is operated.

The apparatus may include an acoustic generator that generates at least one sound under the control of the controller when the memory switch is operated.

Also, the memory switch may be installed on the tail gate.

Various aspects of the present invention provide for a method of setting the maximum opening angle of a power tail gate for a vehicle, which includes: a step of storing information about rotating direction and speed (rpm) of a motor, which are detected by a hall sensor, in a controller when an operation signal of a memory switch is sustained for a set time in the state of an open tail gate; and a step of the controller controlling operation of a power supply supplying power to the motor on the basis of the information from the hall sensor which is stored in the controller when a main switch is operated.

The set time required to determine the operation signal of the memory switch may include a primary set time and a secondary set time that is longer than the primary set time. If the operation signal of the memory switch is sustained for a time within a range from the primary set time to the secondary set time, the controller may store the information detected by the hall sensor.

If the operation signal of the memory switch is sustained for longer than the secondary set time, the controller may delete and initialize the stored information from the hall sensor.

The primary set time may range from 2 sec to 3 sec and the secondary set time may range from 4 sec to 5 sec.

When the set time for the operation signal of the memory switch exceeds the primary and secondary set times, the acoustic generator operated under the control of the controller may generate different sounds.

In accordance with the present invention, the maximum opening angle of the tail gate may be adjusted by an angle which a user wants, so that the ease of use by the user can be improved, and furthermore prevent the tail gate from being damaged.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view that explains a conventional power tail gate device.

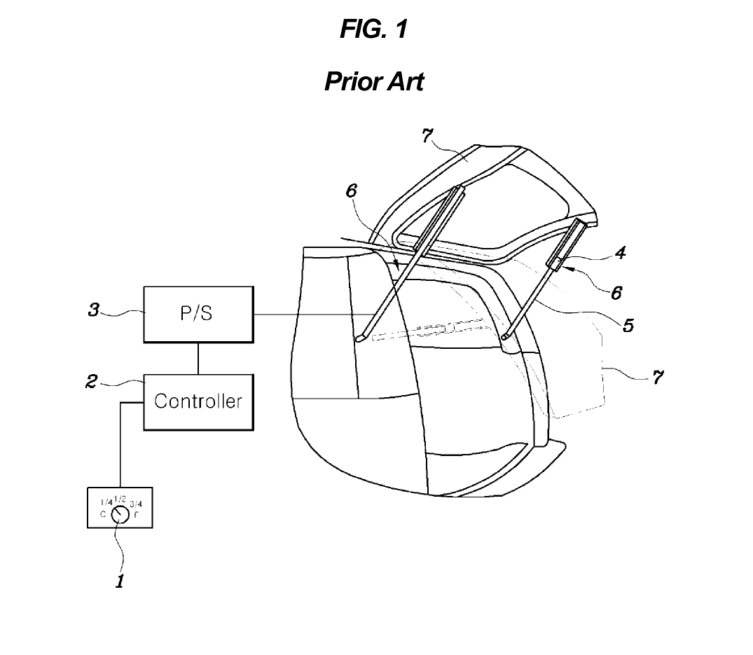

FIG. 2 is a view that explains an exemplary apparatus and method of setting a maximum opening angle of a power tail gate for a vehicle according to the present invention.

FIG. 3 is a view that explains an exemplary actuator used in the apparatus according to the present invention.

FIG. 4 is a flowchart that explains an exemplary method of using an exemplary apparatus according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

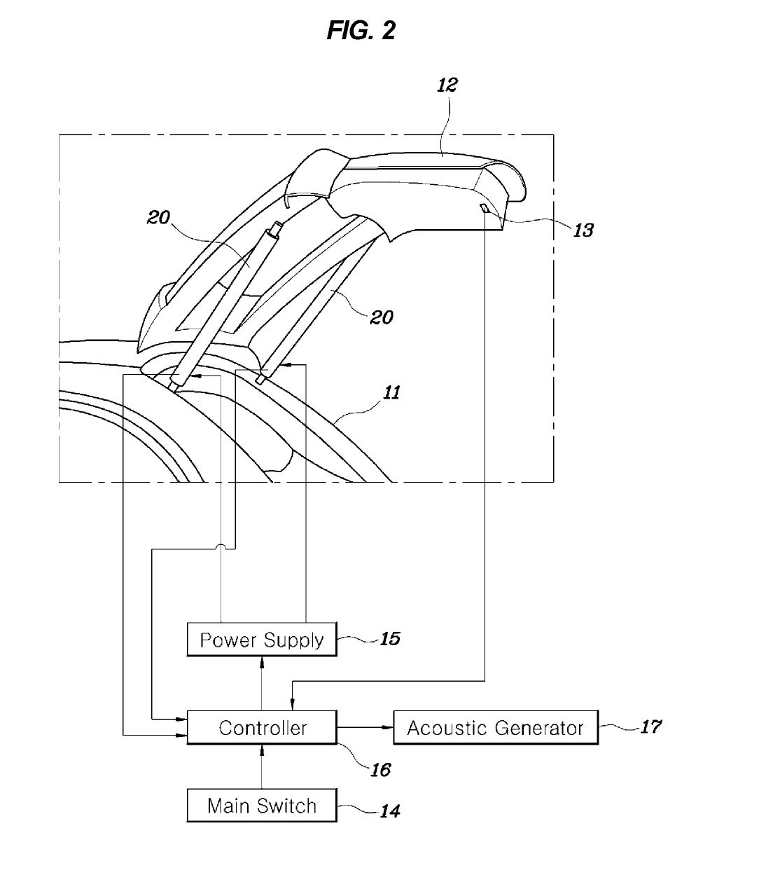

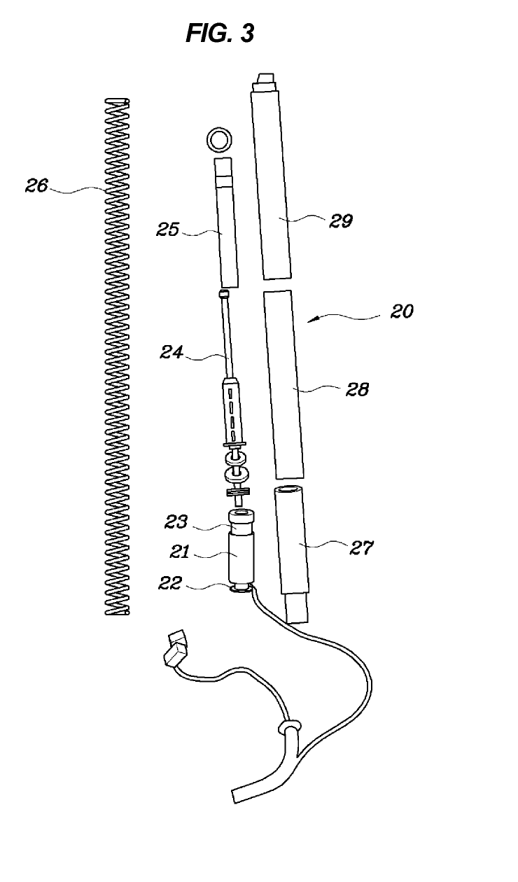

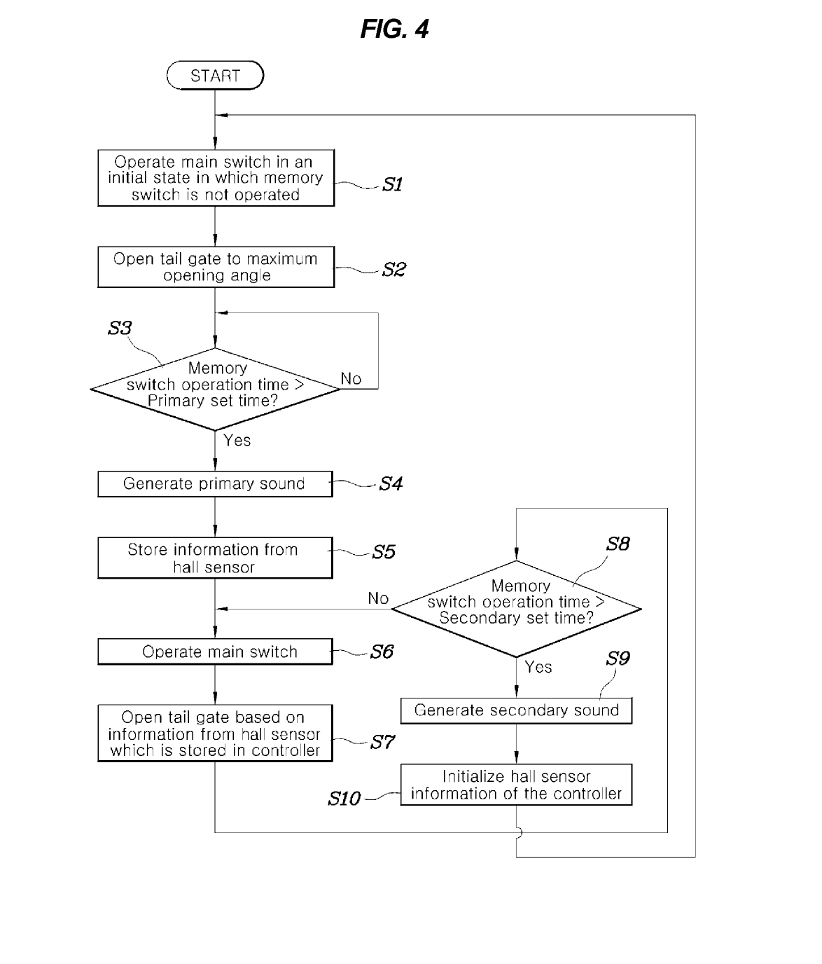

As shown in FIGS. 2 to 4, an apparatus for setting the maximum opening angle of a power tail gate for a vehicle according to various embodiments of the present invention includes an actuator 20 that is installed to connect a vehicle body 11 and a tail gate 12 and has a motor 21 providing power to open and close the tail gate 12, a hall sensor 22 installed on the actuator 20 so as to be able to detect the rotating direction and speed (rpm) of the motor, a memory switch 13 that is operated by a user so as to be able to store information detected by the hall sensor 22 in the state in which the tail gate 12 is open, a controller 16 that receives and stores the information from the hall sensor 22 when the memory switch 13 is operated and controls operation of a power supply 15 supplying power to the motor 21 on the basis of the stored information from the hall sensor 22 when a main switch 14 is operated, and an acoustic generator 17 that generates at least one sound under the control of the controller 16 when the memory switch 13 is operated.

Here, the memory switch 13 may be installed inside a lower end of the tail gate 12 for the ease of use by a user, and the main switch 14 may be installed on a driver's seat door or a center fascia panel so as to be easily operated from the interior of the vehicle by a driver. However, the present invention is not limited to this configuration.

Meanwhile, functions of the actuator 20 include both a function of supporting a load of the tail gate 12 and a function of opening/closing the tail gate 12. Internal components of the actuator 20 include a motor 21, a planetary gear 23 increasing a rotational force of the motor 21, a spindle 24 rotated by the increased rotational force, a nut 25 moving along the spindle 24 when the spindle 24 is rotated, and a spring 26 elastically supporting the load of the tail gate 12. External components of the actuator 20 include a lower case 27 coupled to the vehicle body 11 at one end thereof, a middle case 28 protecting the spindle 24, and an upper case 29 connected to the tail gate 12 at one end thereof, coupled with the nut 25, and opening/closing the tail gate 12 while being linearly displaced relative to the middle case 28 by the power of the motor 21.

The actuator 20 configured as mentioned above is already widely known in the art, and so its detailed description will be omitted.

The method of setting the maximum opening angle of a power tail gate for a vehicle according to various embodiments of the present invention includes a step of storing information about rotating direction and speed (rpm) of the motor 21, which are detected by the hall sensor 22, in the controller 16 when an operation signal of the memory switch 13 is sustained for a set time in the state of an open tail gate 12, and a step of the controller 16 controlling operation of the power supply 15 supplying power to the motor 21 on the basis of the information from the hall sensor 22 which is stored in the controller 16 when the main switch 14 is operated.

Here, the set time required to determine the operation signal of the memory switch 13 is made up of a primary set time and a secondary set time that is longer than the primary set time. If the operation signal of the memory switch 13 is sustained for a time within a range from the primary set time to the secondary set time, the controller 16 stores the information detected by the hall sensor 22. If the operation signal of the memory switch 13 is sustained for longer than the secondary set time, the controller 16 deletes and initializes the information detected by the hall sensor 22.

In various embodiments, preferably, the primary set time ranges from 2 sec to 3 sec and the secondary set time ranges from 4 sec to 5 sec. The present invention is not limited to these ranges.

However, for the easy use of a user, the set time for the operation signal of the memory switch 13 may be properly adjusted.

When the set time for the operation signal of the memory switch 13 exceeds the primary set time, and when the set time for the operation signal of the memory switch 13 exceeds the secondary set times, the acoustic generator 17 operated under the control of the controller 16 may be configured to generate different sounds, of which one is for the former and the other for the latter, so that a user can easily identify the set time for the operation signal of the memory switch 13.

Hereinafter, how to use the apparatus according to the present invention will be described.

When the tail gate 12 is closed to the vehicle body 11 (the closed state) and the memory switch 13 is not operated (the initial state), a user operates the main switch 14 (step S1). Then, a locking device of the tail gate 13 is released by a control signal of the controller 16, and the power supply 15 receives the control signal of the controller 16 and supplies power to the motor 21 of the actuator 20. The upper case 29 supplied with the power of the motor 21 performs extensible movement, so that the tail gate 12 opens.

As long as the user does not operate the main switch 14 again while the tail gate 12 is opening, the tail gate 12 opens to the maximum opening angle (step S2).

When a user wants to set the maximum opening angle of the tail gate 12 to the desired angle to suit his or her needs, the user opens the tail gate 12 to the desired opening angle, and then pushes the memory switch 13 until the primary set time (from 2 sec to 3 sec) has elapsed (step S3).

Then, the acoustic generator 17 generates a sound. The user hears the generated sound and stops pushing the memory switch 13 (step S4).

When the user pushes the memory switch 13 as mentioned above, the hall sensor 22 detects information about the rotating direction and speed (rpm) of the motor 21. The information detected by the hall sensor 22 is stored in the controller 16 (step S5). From this moment, when the user operates the main switch 14, the controller 16 controls operation of the power supply 15 supplying power to the motor 21 on the basis of the stored information from the hall sensor 22 (step S6).

Thus, the tail gate 12 is opened only by the angle, which is stored in the controller 16 by the operation of the memory switch 13, under the control of the controller 16 as the maximum opening angle, so that the ease of use by the user can be improved (step S7).

When the user wants to adjust the maximum opening angle of the tail gate 12 again, the user pushes the memory switch 13 until the operation signal of the memory switch 13 is sustained for longer than the second set time (from 4 sec to 5 sec) (step S8).

Then, the acoustic generator 17 generates a sound different from that generated when the primary set time has elapsed. The user hears the generated sound and stops pushing the memory switch 13 (step S9).

When the pushing operation of the memory switch 13 lasts longer as mentioned above, the controller 16 deletes the stored information from the hall sensor 22 and initializes the information (step S10). From this moment, the opening angle of the tail gate 12 opened by the operation of the main switch 14 reaches the maximum again.

Thus, the user opens the tail gate 12 again by the desired angle. In this state, the user operates the memory switch 13 again, thereby adjusting the maximum opening angle again.

According to the present invention as described above, the maximum opening angle of the tail gate 12 can be adjusted by an angle which the user wants, so that the user can easily adjust the maximum opening angle of the tail gate, and furthermore prevent the tail gate 12 from being damaged.

Further, one will appreciate that the method of setting and re-adjusting the maximum opening angle of the tail gate 12 using the memory switch 13 may be realized in various ways in accordance with the present invention.

In addition, although the present disclosure primarily describes a power tail gate for a recreation vehicle (RV), one will appreciate that the principles discussed herein may be applied to a power trunk lid of a deluxe motorcar.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for setting a maximum opening angle of a powered tail gate for a vehicle, comprising:
an actuator operably connecting a vehicle body and the tail gate and has a motor providing power to open and close the tail gate;
a hall sensor installed on the actuator so as to be able to detect both rotating direction and speed (rpm) of the motor;
a memory switch operated by a user so as to be able to store information detected by the hall sensor in a state in which the tail gate is open.

2. The apparatus according to claim 1, further comprising a controller that receives and stores the stored information from the hall sensor when the memory switch is operated, and controls operation of a power supply supplying power to the motor on the basis of the stored information from the hall sensor when a main switch is operated.

3. The apparatus according to claim 1, further comprising an acoustic generator that generates at least one sound under the control of the controller when the memory switch is operated.

4. The apparatus according to claim 1, wherein the memory switch is installed on the tail gate.

5. A method of setting a maximum opening angle of a powered tail gate for a vehicle, comprising:
a step of storing information about both rotating direction and speed (rpm) of a motor, which are detected by a hall sensor, in a controller when an operation signal of a memory switch is sustained for a set time in a state in which the tail gate is open; and
a step of the controller controlling operation of a power supply supplying power to the motor on the basis of the stored information from the hall sensor which is stored in the controller when a main switch is operated.

6. The method according to claim 5, wherein:
the set time required to determine the operation signal of the memory switch is made up of a primary set time and a secondary set time longer than the primary set time; and
if the operation signal of the memory switch is sustained for a time within a range from the primary set time to the secondary set time, the controller stores the stored information detected by the hall sensor.

7. The method according to claim 6, wherein, if the operation signal of the memory switch is sustained more than the secondary set time, the controller deletes the stored information from the hall sensor and initializes the stored information.

8. The method according to claim 7, wherein:
the primary set time ranges from 2 sec to 3 sec; and
the secondary set time ranges from 4 sec to 5 sec.

9. The method according to claim 7, wherein, when the set time for the operation signal of the memory switch exceeds the primary and secondary set times, the acoustic generator operating under the control of the controller generates different sounds.
